(19) United States
(12) Patent Application Publication
(10) Pub. No.: US 2010/0045701 A1
(43) Pub. Date: Feb. 25, 2010

(54) AUTOMATIC MAPPING OF AUGMENTED REALITY FIDUCIALS

(75) Inventors: Katherine Scott, Ann Arbor, MI (US); Douglas Haanpaa, Dexter, MI (US); Charles J. Jacobus, Ann Arbor, MI (US)

Correspondence Address: GIFFORD, KRASS, SPRINKLE,ANDERSON & CITKOWSKI, P.C, PO BOX 7021, TROY, MI, 48007-7021, US

(73) Assignee: Cybernet Systems Corporation, Ann Arbor, MI (US)

(21) Appl. No.: 12/546,266

(22) Filed: Aug. 24, 2009

Related U.S. Application Data
(60) Provisional application No. 61/091,117, filed on Aug. 22, 2008.

(51) Int. Cl. G09G 5/00; G06K 9/00; H04N 7/18

(52) U.S. Cl. 345/633; 382/100; 348/135; 348/E07.085

(57) ABSTRACT

Systems and methods expedite and improve the process of configuring an augmented reality environment. A method of pose determination according to the invention includes the step of placing at least one synthetic fiducial in a real environment to be augmented. A camera, which may include apparatus for obtaining directly measured camera location and orientation (DLMO) information, is used to acquire an image of the environment. The natural and synthetic fiducials are detected, and the pose of the camera is determined using a combination of the natural fiducials, the synthetic fiducial if visible in the image, and the DLMO information if determined to be reliable or necessary. The invention is not limited to architectural environments, and may be used with instrumented persons, animals, vehicles, and any other augmented or mixed reality applications.

### REFERENCE TO RELATED APPLICATION

This application claims priority from U.S. Provisional Patent application Ser. No. 61/091,117, filed Aug. 22, 2008, the entire content of which is incorporated herein by reference.

### GOVERNMENT SUPPORT

This invention was made with Government support under Contract No. W91CRB-08-C-0013 awarded by the United States Army. The Government has certain rights in the invention.

### FIELD OF THE INVENTION

This invention relates generally to augmented reality (AR) systems and, in particular, to pose determination based upon natural and synthetic fudicials and directly measured location and orientation information.

### BACKGROUND OF THE INVENTION

Augmented reality (AR), also called mixed reality, is the real-time registration and rendering of synthetic imagery onto the visual field or real time video. AR Systems use video cameras and other sensor modalities to reconstruct a camera's position and orientation (pose) in the world and recognize the pose of objects for augmentation (addition of location correlated synthetic views overlaid over the real world). The pose information is used to generate synthetic imagery that is properly registered (aligned) to the world as viewed by the camera. The end user is the able to view and interact with this augmented imagery to acquire additional information about the objects in their view, or the world around them. AR systems have been proposed to improve the performance of maintenance tasks, enhance healthcare diagnostics, improve situational awareness, and create training simulations for military and law enforcement training.

AR systems often employ fiducials, or image patterns with a known size and configuration to track the position and orientation (pose) of the user or a camera, or to determine the user's position with respect to a known model of the environment or a specific object. The fiducial serves two purposes; the first is determination of the position of the user's vantage point with respect to the fiducial, and second is relating the position of the user to a map or model of the environment or item to be augmented.

Augmented reality fiducials can take two forms. According to one technique, a target is constructed to allow reliable detection, identification and localization of a set of four or more non-collinear points where the arrangement and location of the points is known a priori. We call this a synthetic fiducial. The second approach is to use a set of four or more readily identifiable naturally occurring non-collinear patterns (or image features, for instance, a small image patch) in an image that can be reliably detected, identified, localized, and tracked between successive changes in a camera pose. We call these natural fiducials.

Early working in AR systems focused on methods for overlaying 3D cues over video and sought to use tracking sensor alone to correspond the user's viewing position with the abstract virtual world. An example is U.S. Pat. No. 5,815,411, issued to Ellenby and Ellenby on Sep. 29, 1998, which describes using a head mounted display based augmented reality system that uses a position detection device that is based on GPS and ultrasound, or other triangulations means. No inertial, optical, magnetic or other tracking sensor is described in this patent, but it is extensible other sensors that directly provide head position to the augmentation system.

The problem with using directly measured location and orientation sensors (DMLOs) alone is that they have one or more of the following problems that reduce correspondence accuracy:
(1) Signal noise that translates to potentially too large a circular error probability (CEP)
(2) Drift over time
(3) Position/orientation dependent error anomalies due to the external environment—proximity to metal, line of sight to satellites or beacons, etc.
(4) Requirement for preposition magnetic or optical beacons (generally for limited area indoor use only)

To overcome errors or to improve pointing accuracy U.S. Pat. No. 5,856,844, issued to Batterman and Chandler on Jan. 5, 1999 describes a barcode like fiducial system for tracking the pose of a head mounted display and pointing device. For this patent fiducials are placed on the ceiling and detected using a camera pointed towards the ceiling. An alternative described by U.S. Pat. No. 6,064,749 issued to Hirotsa et al. on May 16, 2000 discusses an augmented reality system that uses stereoscopic cameras and a magnetic sensor to track the user's head as an orientation sensor. Both of these patents are limited to applications in enclosed areas where pre-placement of sensor, magenetic beacons, and ceiling located barcodes is possible.

U.S. Pat. No. 6,765,569 issued to Neumann and You on Jul. 20, 2004 describes a method for generating artificial and natural fiducials for augmented reality as well as a means of tracking these fiducials using a camera. Fiducials are located and stored using an auto calibration method. The patent discusses a host of features that can be used for tracking, but does not describe how feature sets for tracking are computed. This is significant because while the mathematics for acquiring position and orientation from image data has been known for over 40 years, using natural features extracted by image processing as fiducials has the potential for introducing sizable errors into a pose determination system due to errors in the image processing system algorithms.

To overcome image processing issues through simplifications, U.S. Pat. No. 6,922,932 issued to Foxlin on Jul. 26, 2005 describes a method of integrating an inertial measurement unit and optical barcode pose recovery system into a mapping paradigm that includes both stationary and moving platforms. Because the barcodes are more reliably detected and identified, this system in closed setting can be more reliable than that described in 6,765,569.

U.S. Pat. No. 7,231,063 issued to Naimark and Foxling on Jun. 12, 2007 discusses a means of determining augmented reality pose by combining an inertial measurement device with custom rotation invariant artificial fiducials. The system does not combine the use of natural objects as a means of pose recovery. This patent is very focused on the specific rotational invariant design of its fiducials and the application of these to augmented reality.

The conundrum of current augmented reality systems is whether to rely on synthetic or barcode fiducials for camera pose reconstruction or to use natural features detected from image processing of natural scene imagery. While synthetic fiducials allow cameras and video processing systems to quickly locate objects of a known shape and configuration, it limits augmentation to areas that have pre-placed and registered. The placement and localization of synthetic fiducials is time consuming and may not cover enough of the environment to support augmentation over the entire field of action. However, using only natural features has proven unreliable because:
(1) Detection and Identification algorithms have not been robust
(2) Camera calibration is difficult so accuracy suffers
(3) Feature tracking has been unreliable without manual supervision

Collectively, this has made computer-vision tracking and pose determination unreliable.

### SUMMARY OF THE INVENTION

This invention resides in expediting and improving the process of configuring an augmented reality environment. A method of pose determination according to the invention includes the step of placing at least one synthetic fiducial in a real environment to be augmented. A camera, which may include apparatus for obtaining directly measured camera location and orientation (DLMO) information, is used to acquire an image of the environment. The natural and synthetic fiducials are detected, and the pose of the camera is determined using a combination of the natural fiducials, the synthetic fiducial if visible in the image, and the DLMO information if determined to be reliable or necessary.

The artificial construction of synthetic fiducials is described in the form of a bar code. Natural fiducials may be identified in natural video scenes as a cloud or cluster of subfeatures generated by natural objects if this cloud meets the same grouping criteria used to form artificial fiducials. The systems and methods are particularly effective when the camera has a wide field of view and fiducuals are spaced densely.

The use of the DLMO information may not be necessary is cases where the pose of a known fiducial may be used to infer to pose of an unknown fiducial. In particular, according to a patentably distinct disclosure, the pose of each unknown fiducial is determined using the pose of a known fiducial and the offset between the two fiducials. It is assumed that the known fiducial and the unknown fiducial are visible in successive camera views that are connected by a known camera offset or tracked motion sweep. It is also assumed that fiducial possesses a unique identifying information which can be linked to its pose (position and orientation) in 3D real space once the fiducial has been identified and located.

The invention therefore provides a system and method for (a) forming or exploiting synthetic of natural fiducials, (b) determining the pose of each fiducial with respect to a fiducial with a known position and orientation, and (c) relating that pose to a virtual 3D space so that virtual objects can be presented to a person immersed in virtual and real space simultaneously at positions that correspond properly with real objects in the real space.

Additional aspects of the invention include systems and methods associated with: determining the pose of a series of man-made fiducials using a single initial fiducial as a reference point (e.g. daisy-chained extrinsic calibration); determining the position of natural fiducials using structure from motion techniques and a single man-made fiducial; determining the position of natural fiducials using other known natural fiducials;performing real-time pose tracking using these fiducials and handing off between the natural and man-made fiducials; registering natural and man-made fiducials to a 3D environment model of the area to be augmented (i.e. relating the fiducial coordinates to a 3D world coordinate system); using a collection of pre-mapped natural fiducials for pose determination; recalling natural fiducials based on a prior pose estimate and a motion model (fiducial map page file); storing and matching natural fiducials as a tracking map of the environment; on-line addition and mapping of natural fiducials (e.g. finding new natural fiducials and adding them to the map); and determining and grouping co-planar natural fiducials, or grouping proximal fiducials on a set of relevant criteria as a means of occlusion handling.

The invention is not limited to architectural environments, and may be used with instrumented persons, animals, vehicles, and any other augmented or mixed reality applications.

### BRIEF DESCRIPTION OF THE DRAWINGS

FIG. 1 is an overview flow diagram illustrating major processes according to the invention;

FIG. 2 depicts an example of Directly Measured Location and Orientation (DMLO) Sensor Fusion;

FIG. 3 shows a camera and apparatus for obtaining directly measured location and orientation (DMLO) information;

FIG. 4 shows how DMLO Measurement is related to camera position through a rigid mount;

FIG. 5 illustrates a setup of an augmented reality (AR) environment;

FIG. 6 is an Illustration of the camera and attached DLMO device imaging a plurality of fiducials;

FIG. 7 illustrates the determination of a fiducial's pose from pose determination estimates of previous fiducials;

FIG. 8 depicts image preprocessing;

FIG. 9 shows synthetic barcode fiducial characteristics;

FIG. 10 is a scan of the image for barcode detection;

FIG. 11 illustrates multiple scans of barcode and barcode corners detection;

FIG. 12 shows the detection of markerless or natural features;

FIG. 13 illustrates a delta tracker position tracking/determination algorithm;

FIG. 14 depicts a known Point tracker position tracking/determination algorithm; and

FIG. 15 shows a conceptual pose fusion algorithm.

### DETAILED DESCRIPTION OF THE INVENTION

This invention includes several important aspects. One aspect of the invention resides in a method for estimating the position and orientation (pose) of a camera optionally augmented by additional directly measuring location and orientation detecting sensors (for instance, accelerometers, gyroscopes, magnetometers, and GPS systems to assist in pose detection of the camera unit, which is likely attached to some other object in the real space) so that its location relative to the reference frame is known (determining a position and orientation inside a pre-mapped or known space).

A further aspect is directed to a method for estimating the position and orientation of natural and artificial fiducials given an initial reference fiducial; mapping the locations of these fiducials for latter tracking and recall, then relating the positions of these fiducials to 3D model of the environment or object to be augmented (pre-mapping a space so it can be used to determine the camera's position moving through it accurately).

The methods disclosed include computer algorithms for the automatic detection, localization, mapping, and recall of both natural and synthetic fiducials. These natural and synthetic fiducials are used as an optical indication of camera position and orientation estimation. In conjunction with these optical tracking methods we describe integration of algorithms for the determination of pose using inertial, magnetic and GPS-based measurement units that estimate three orthogonal axes of rotation and translation. Devices of this type are commercially available accurate over both short and long time intervals to sub degree orientation accuracy and several centimeter location accuracy so they can be used to related one camera image location to another by physical track measurement.

According to the invention, multiple pose detection methodologies are combined to overcome the short-comings of using only synthetic fiducials. In the preferred embodiment, three pose detection methodologies are used, with the results being fused through algorithms disclosed herein.

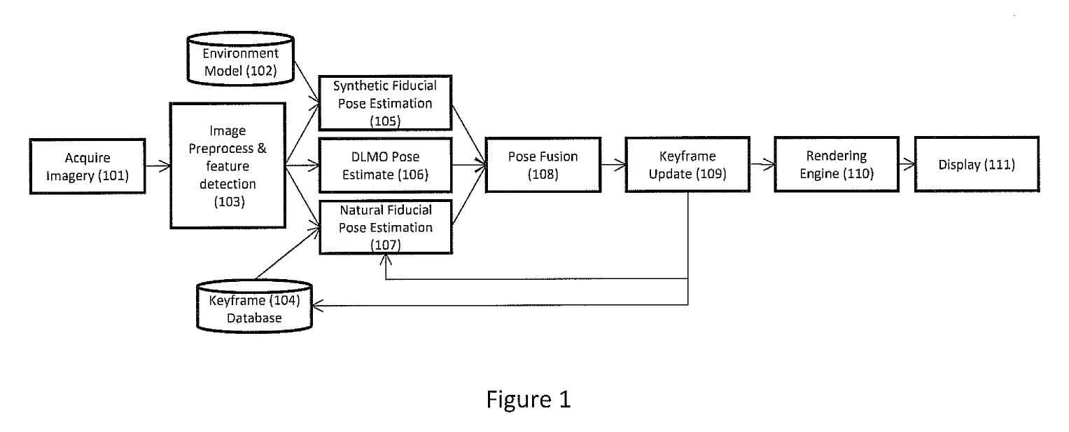

Making reference to FIG. 1, synthetic fiducials (105) support reliable detection, identification, and pose determination. Directly measured location and orientation information (DLMO, 106) is derived from inertial measurement, GPS or other RF location measurement, and other location measurement from sensors (altimeters, accelerometers, gyroscopes, magnetometers, GPS systems or other acoustic or RF locator systems). Clusters of local features of the natural environment (corners, edges, etc.) are used in combination to form natural fiducials for pose tracking (107). These natural fiducials can be extracted using a variety of computer vision methods, can be located relative to a sparse set of synthetic fiducials, and can be identified and localized in a manner similar to that used to identify synthetic fiducials.

Both synthetic and natural fiducials are preferably recorded using a keyframing approach (104) and (109) for later retrieval and tracking. During pre-mapping of an area, keyframes record the features (synthetic and natural) in a camera image as well as the camera's pose. By later identifying some of these features in a cameras view and recalling how these features are geometrically mutually related, the position and orientation of the camera can be estimated.

The DLMO detecting sensors are used between camera views with identifiable synthetic or natural fiducials (not identifiable due to imaging defects like camera blur or low lighting, or just because the view does not contain any pre-mapped fiducials). The DMLO unit (106) may use a number of sensors that can collectively be fused by a software estimator to provide an alternative means of camera location. Generally all such sensors have estimation defects which can to some degree be mitigated by sensor fusion methods including Kalman Filtering, Extended Kalman Filtering, and use of fuzzy logic or expert systems fusion algorithms that combine the sensor measurement based on each's strengths and weaknesses:

TABLE I
Example Directly Measured Location and Orientation (DMLO) Sensors

| Sensor Type | What is Measured | Strengths | Weaknesses |
|---|---|---|---|
| 3 axis | Angular accelerations or | Requires no reference to | Orientation changes |
| Gyroscope | turning motions in any | outside features or | determined from |
| | orientation direction. Over | references for short periods. | gyroscopes random walk |
| | longer periods also includes | No spontaneous jumps due | & drift over time |
| | measurement of Earth's | to noise or detection | |
| | rotation. | uncertainties. | |
| 3-Axis | Acceleration in any direction | Requires no reference to | Location changes |
| Accelerometer | and when used in an Earth | outside features or | determined from |
| | frame of reference in the | references for (very) short | accelerometers random |
| | absence of other | periods. No spontaneous | walk & drift over (fairly |
| | accelerations, measures the | jumps due to noise or | short) times |
| | Gravity vector down) | detection uncertainties. | |
| 3-Axis | Earth magnetic vector | Provides a drift-free | Correctness is affected |
| Magnetometer | (projected on to a vector | absolute orientation | by: |
| | perpendicular to Earth's | measure (relative to | Proximal ferromagnetic |
| | Gravity vector, this is | magnetic North) | materials |
| | magnetic North) | | Area of operation on |
| | | | the Earth's surface |
| | | | (poor performance |
| | | | nearer the poles and |
| | | | changes over the |
| | | | surface due to magnetic |
| | | | field variations) |
| Pressure | Altitude relative to sea level | Provides an absolute | Accuracy limited to about |
| Altimeter | | altitude reference | 5 meters and is affected |
| | | | by barometric pressure |
| | | | changes |
| Radar | Altitude above ground | Provides an absolute | Must know the ground |
| Altimeter | | altitude reference relative to | location for an absolute |
| | | ground | measure and these |
| | | | devices are relatively |
| | | | large and bulky |
| GPS Location | Latitude, longitude and | Provides an absolute, non- | Must have line of sight to |
| | altitude | drifting Lat, Lon, and | four to six satellites (i.e. |
| | | Altitude measure | does not work well |
| | | | indoors and some outdoor |
| | | | locations). Due to |
| | | | detection noise and other |
| | | | effects, GPS locations |
| | | | have a random walk jitter. |
| | | | Units with less jitter and |
| | | | more accuracy are |
| | | | bulkier. |
| RF-Radio | Angle to a radio beacon | Provides direction to the | Requires three sightings |
| Direction | emitter | beacon | to localize |
| Finders | | | |
| Acoustic | Range to a surface or object | Provides range to a surface | Requires two sightings |
| Direction | | | and these may be |
| Finders | | | defective depending on |
| | | | surface orientation |
| Laser Beacon | Angle to a reflector or laser | Like RF and Acoustic | Requires two or three |
| Localizers | emitter | combined, depending on | sightings and these may |
| | | type may provide range | be defective depending |
| | | and/or direction angle | on surface orientation |

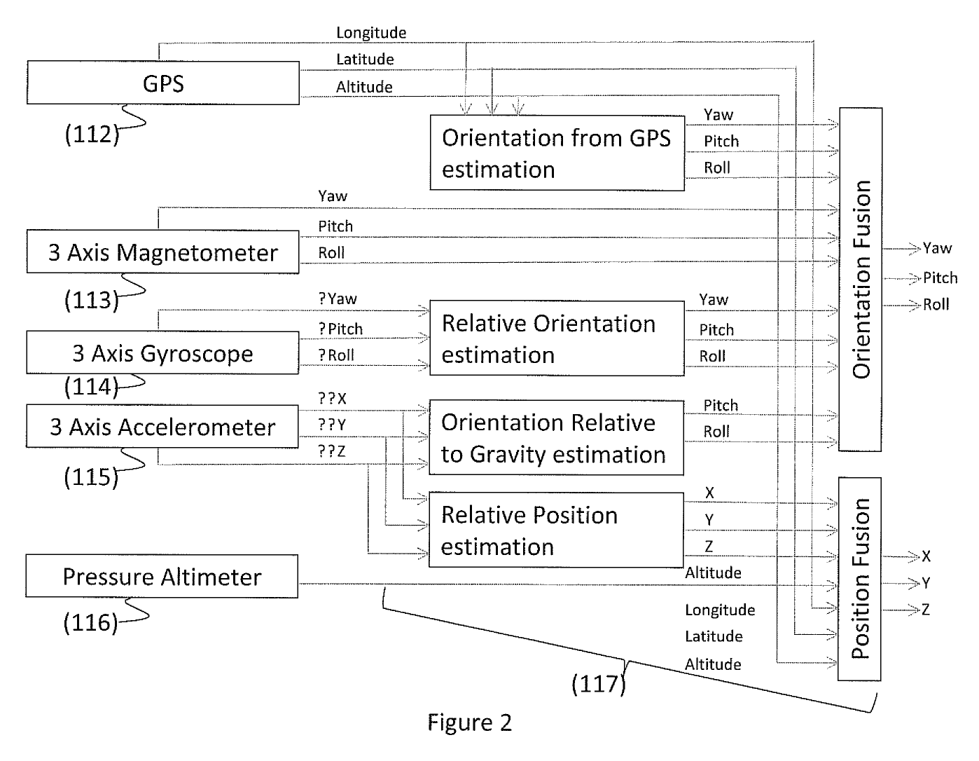

As one preferred example of such a sensor fusion, FIG. 2 shows a combination of GPS (112), pressure altimeter (116), accelerometers (115), gyroscopes (114), and magnetometer (113) which in 2009 can be packaged into a box nominally smaller that 2″×2″×3″. These sensors provide:
Absolute latitude, longitude, and altitude when allowed line of sight to sufficient satellites and in the absence of GPS jamming (from GPS contribution) and orientation from a string of several GPS measurements
Less accurate estimate of altitude relative to sea level (from altimeter contribution)
Estimate of orientation relative to magnetic North (from magnetometer with caveat that any proximal ferric object will throw off the orientation substantially)
Estimate of pitch angle and roll angle (the Gravity vector measured by accelerometers)
Estimate of orientation and position relative to the last valid absolute fix (the gyroscopes and accelerometers as an inertial guidance system which drifts more as the time from the last fix gets longer)

Regardless of fusion algorithm (117) or which combination of sensors is used to implement it, in our method as disclosed, the DMLO attached to the camera provides a capability for (a) determining an absolute camera position and orientation in the real space and (b) a measure of relative position/orientation change between two time periods of the camera position. In the absence of precise GPS and a reliable absolute orientation sensor, as is the case in some outdoor environments and indoors, DMLO camera position and orientation estimation is whole relative to the previous absolute fix and will drift (fairly quickly) over time. As such, the disclosed camera-based fiducial identification and localization method effectively corrects for this defect.

Continuing the reference to FIG. 1, after pose determination (by any of the three methods, (105), (106), or (107)) (by estimation via the DMLO and fusion with camera/fiducial based estimation) is completed, the pose estimate of the camera, the camera's current image, and the camera's intrinsic parameters can be used to control a render engine (110) so as to display images (111) of the real environment or object overlaid by augmentations (generated synthetic 3D or 2D graphics and icons register to and superimpose on the real images from camera input). This augmented imagery can be rendered onto a head mounted display, touch screen display, cell phone, or any other suitable rendering device.

### Hardware

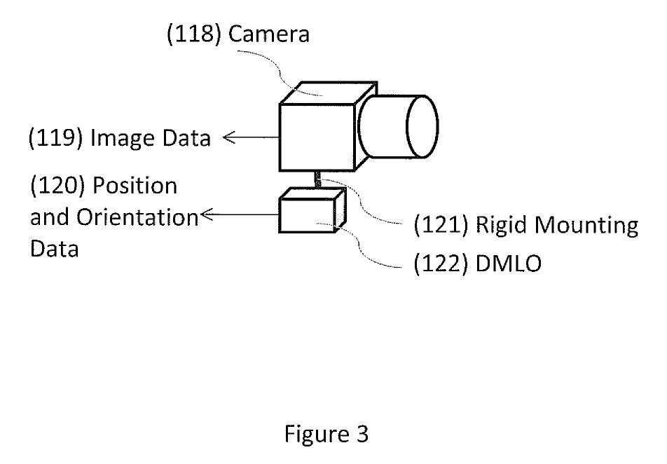

A preferred embodiment (FIG. 3) of an augmented reality system according to the invention uses a camera (118) capable of producing digital imagery and is substantially improved by also including a Directly Measured Location and Orientation (DMLO) Sensor suite (122) including sensor described in the last section (GPS, inertial measurement sensor, magnetometer and/or altimeter). The camera provides grayscale or color images (119), and provides a sufficient field of view to the end user. We have implemented a system using 640×480 pixel cameras that can operate at up to 60 Hz. Higher or lower camera update rates and larger or smaller resolutions, or using alternative images sources (for instance, infrared, imaging laser radar, or imaging radar systems) may be used to provide higher or lower position determination accuracy and improved or restricted acuity to the user viewing augmented video data without changing the basic system approach we describe.

The DMLO is rigidly mounted (121) to the camera with a known position and orientation offset from the camera's optical axis. It is important this connection be rigid as slippage between the devices can affect overall performance. When a head mounted display by the user to display augment video, it is desirable to rigid mount the camera/DMLO subsystem in a fixed position and orientation with respect the head mounted display. The offsets between the devices are acquires as part of the calibration procedure. The DMLO produces position and orientation estimates of the camera optical axis (120).

### Calibration

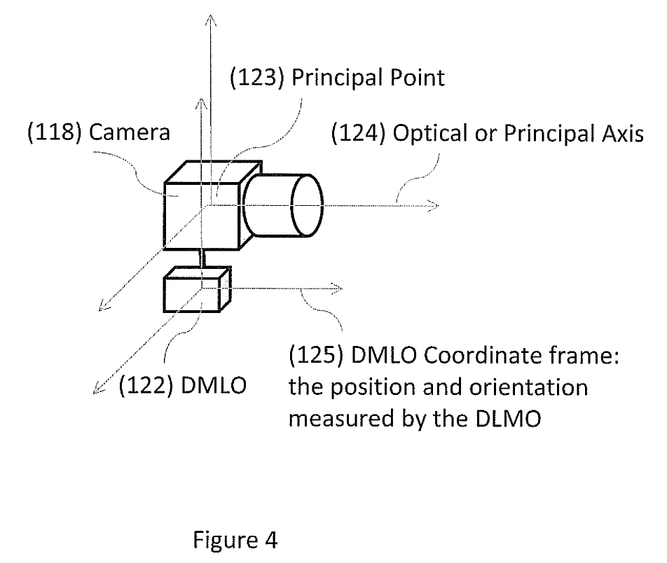

Before the augmented reality sensor system (camera and DLMO pair) can successfully be used to reconstruct pose it must first go through a sensor calibration process involving both the camera sensor and the DMLO unit (FIG. 4). The calibration procedure is used to determine the camera's intrinsic calibration matrix, and encodes the camera's focal length, principal point (123), skew parameters, radial, and tangential distortions this intrinsic camera model maps 3D world space coordinates into homogenous camera coordinates. The camera's intrinsic calibration matrix is used to remove the distortion effects caused by the camera lens.

For the DLMO it is important to determine any relevant internal calibration (parameters needed by the fusion algorithms (117)) and the 3D transform that relates the position and orientation measured by the DLMO (125) to the affixed camera optical or principal axis (124) and camera principal point.

### Environment Modeling and Extrinsic Calibration

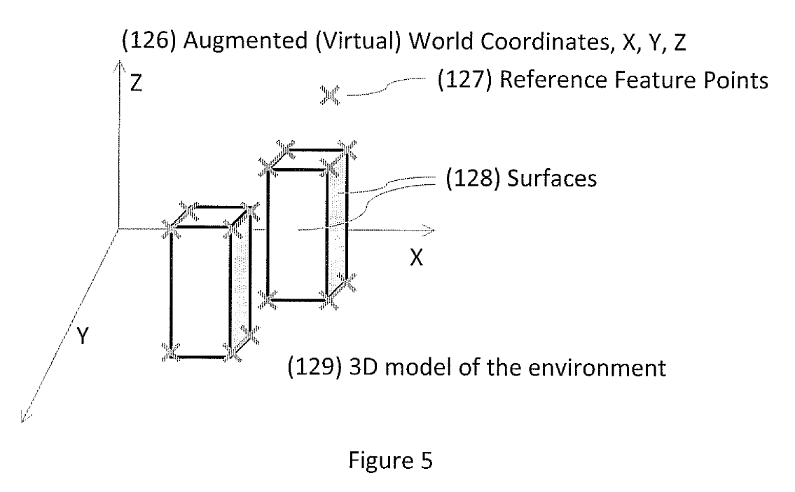

The setup of the augmented reality (AR) environment, FIG. 5, begins by generating an accurate 3D model of the environment (126) to be augmented using surveying techniques to locate key three dimensional reference features (127). These reference features determine the geometry of the surfaces (128) in the environment (walls, floors, ceilings, large objects, etc) so that detail graphics model representations can be built for virtualization of augmentations as surface textures to this model. To map the virtual model of the AR environment (126) to the real world, fiducials must be placed or identified within the real environment and their exact position recorded in terms of both real world coordinates and the corresponding augmented world coordinates (126).

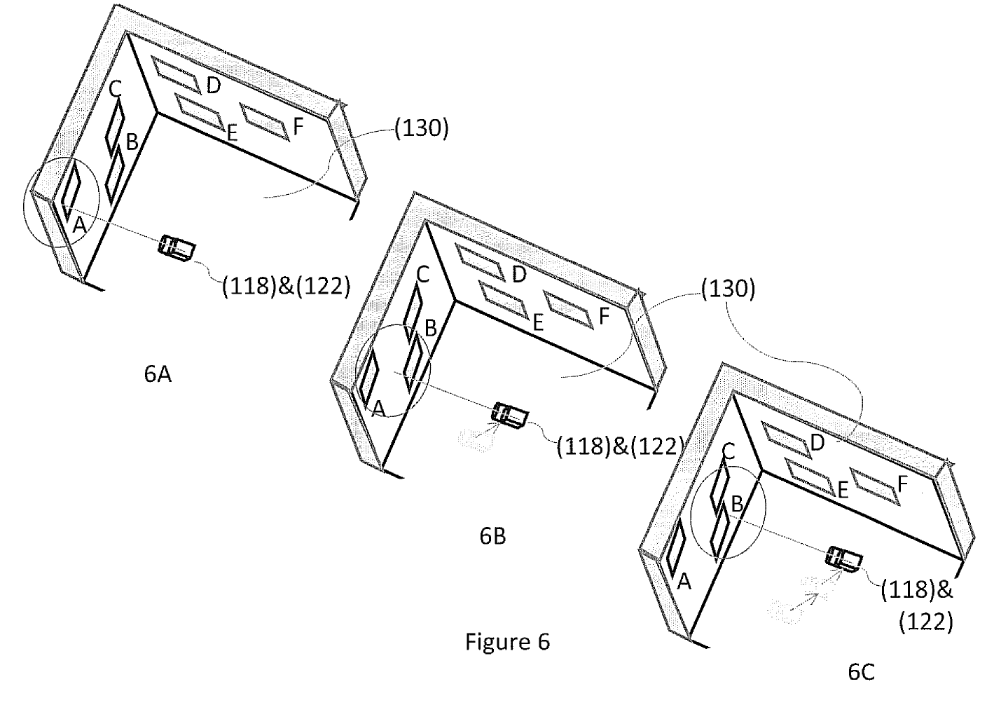

This process can be expedited by using synthetic fiducials pre-placed at surveyed reference feature locations. FIG. 6 illustrates the camera (118) and attached DLMO device (122) that images fiducials A, B, etc. within real environment (130). In FIG. 6A, the pose of the first fiducial A is determined by manual means (placement a known surveyed location) and associated with the fiducual's identifying information. In FIG. 6B, the camera and tracking device has moved so that the field of view now includes fiducial B and the motion track from pointing to A and point to B has been captured by the DLMO tracking device (122). The position and orientation of fiducial B is calculated as the pose of fiducial A plus the offset between A and B. As shown in FIG. 6C, the process continues, wherein the pose of a new fiducial C can then be calculated using the new pose information associated with fiducial B plus the offset from B to C. If two fiducials are included in a single view, the tracking device the offset can be determined purely from the image information eliminated the need for the location DLMO device (122).

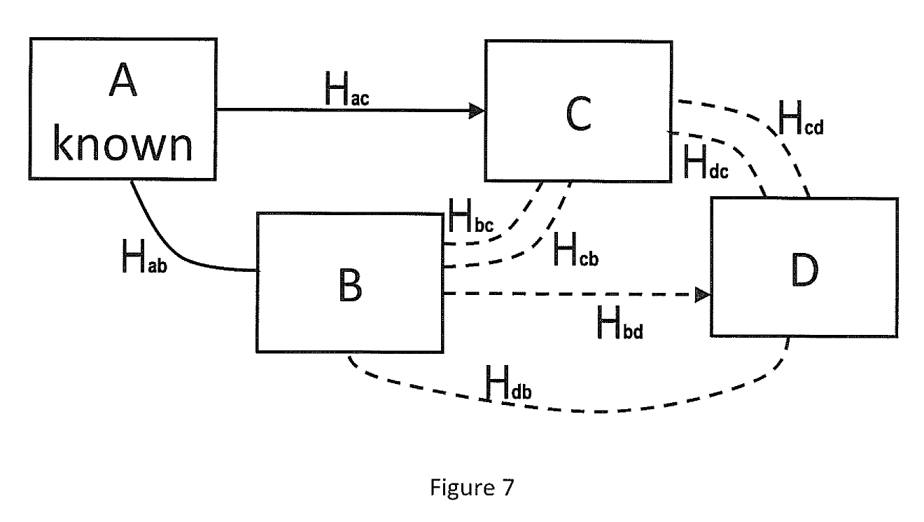

Thus, as shown in FIG. 7, it is possible to “daisy-chain” fiducial information, and determine the fiducial's pose from pose determination estimates of previous fiducials. It is possible to determine the poses of a room or an open area full of fiducials using a single known point.

Large collections of new fiducials can use change in orientation and position from nearby fiducials to affect a more robust position estimate. In FIG. 6, squares represent fiducials (A, B, C, and D as shown in FIG. 6), solid lines indicated a direct estimate of the new fiducial's pose, and dotted lines represent fiducial position and orientation changes based solely on newly encountered fiducials. The known fiducial is used to calculate the Hamiltonian between the unknown fiducials B and C (H_{ab} and H_{ac}). The new pose estimation B and C can then be used to extract the pose of fiducial D. The pose of each new fiducial can be refined using error minimization (for instance, least squares error) critera to select a new pose that best matches the estimates of nearby fiducials.

The rotation and translation between two fiducials to a third fiducial (e.g. H_{cd} and H_{bd}), may be represented by a quaternion, and should represent the same orientation and position. If the position and orientations disagree, error minimization fitting algorithms can be used to further refine the pose estimates by minimizing error propagation between the new fiducials.

Referring back to FIG. 1, once the placed synthetic fiducials positions have been determined and recorded it is then possible to perform an initial mapping of markerless or natural feature points. This is accomplished by recording the camera data (image acquisition (101)) of a number of possible paths throughout the augmented reality environment. From this recorded data we then use the methods described later in the disclosure to determine and record the position of natural fiducials in the form of keyframes (104). To do this we use imagery where synthetic fiducials are visible or DLMO measured translation from known previously identified synthetic fiducials are reliable. From the known location of the synthetic fiducials we are then able robustly estimate the pose of the camera (108).

Through image preprocess and feature detection (103), natural features are identified and matched between successive image frames. Features tracked through multiple views are localized relative to the estimate camera pose through triangulation, determining the feature's location in the 3D real world coordinate frame. Groups of 3D localized features that are visible in a single camera image are collected together a natural fiducial in a keyframe for later recall and use for unknown camera pose estimation.

### Image Acquisition and Preprocessing (103)

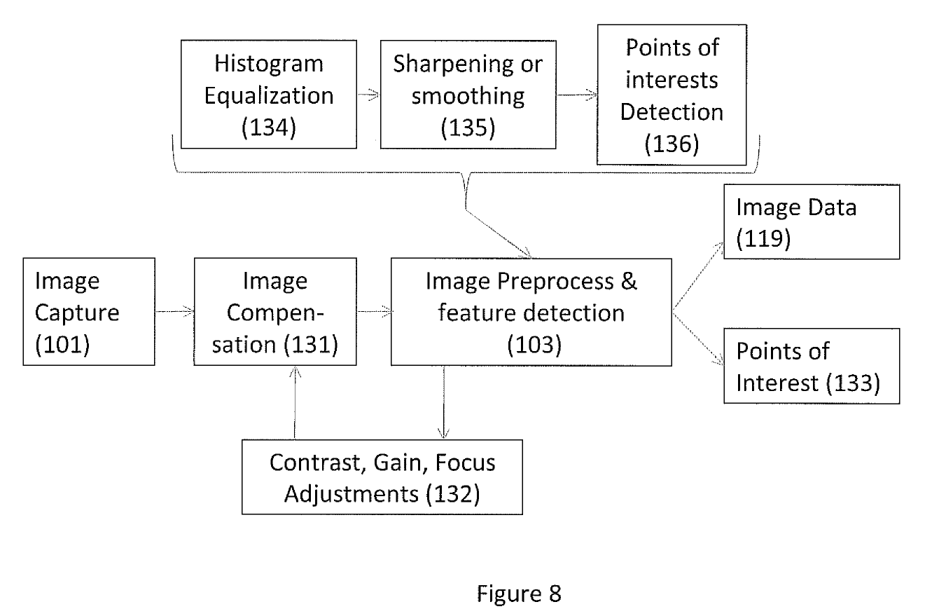

The camera derived natural and synthetic fiducials are detected by Image processing performed on incoming camera images (FIG. 8). The first step in processing provides automatic focus, gain control, and application of the camera's intrinsic calibration matrix to remove aberrations like skew parameters, radial, and tangential distortions, etc (131). This is done so that the location of features in an image can be related to the 3D real space through simple linear projection accurately. These operations may include histogram equalization (134) or equivalent to maximize image dynamic range and improve contrast, Sobel filtering to sharpen edges or smoothing (135), and finally application of a point-of-interest operator (136) that identifies possible natural features that can be keyframed into natural fiducual sets (133). This is further described in the description of forming natural fiducials later.

### Synthetic Fiducial Detection, Identification, and Localization

As indicated previously, synthetic fiducuals are man-made to enhance recognition reliability and are placed in the environment through survey methods to provide reliable tie points between the augmented 3D space and the real 3D space. In the preferred embodiment we implement a kiwi of one-dimensional horizontal bar code as the synthetic fiducial.

Our barcode fiducial system uses simple barcodes that can be printed on standard 8.5″×11″ printer paper in black and while the actual bar code size can be varied to support reliable identification at further or close ranges (for closer ranges a smaller bar code is used and to extend range further larger bar codes are used). These barcodes are easily detected, identified, and then easily located image space. By matching the bar code identified with its matching pre-surveyed location in the real 3D world space, we can quickly determine the approximate camera position and orientation. Alternative synthetic fiducials can be used, some described by prior workers in the bar code field , including rotation invariant codes, two dimensional codes, vertical codes, etc.

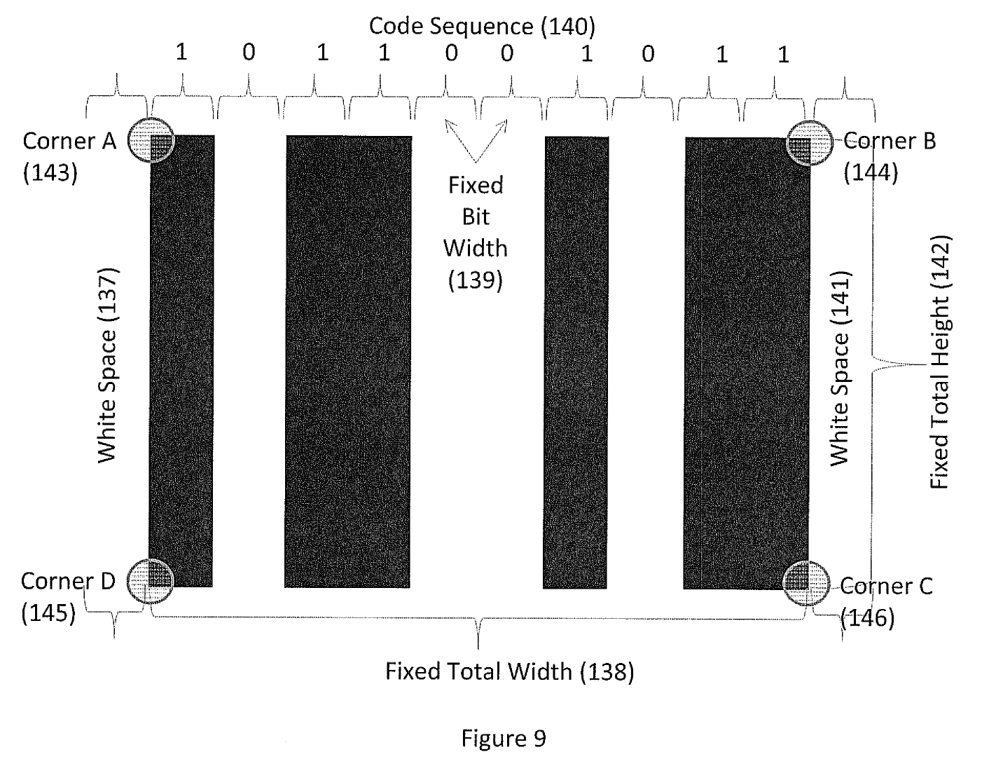

FIG. 9 shows the basic form of one bar code applicable to the invention. Such codes are made from pre-determined width (138) of alternative white and black bars of a standard width (139) and height (142) to width (139) ratio or approximately 10 to 1. Each code begins with a white to black transition (or start code—(137)) and ends with a black to white transition (stop code—(141)). Between the start and stop there are a predetermined number of binary “bits.” Each bit is code black or white representing binary “1” or “0” provides a code sequence (140) which is generally unique in an area. While the number of bits can be varied in an implementation, generally it is prudent to make the code approximately square and contain several alternations between black and white so that the target is not likely to be confused by a naturally occurring set of similar features in the environment.

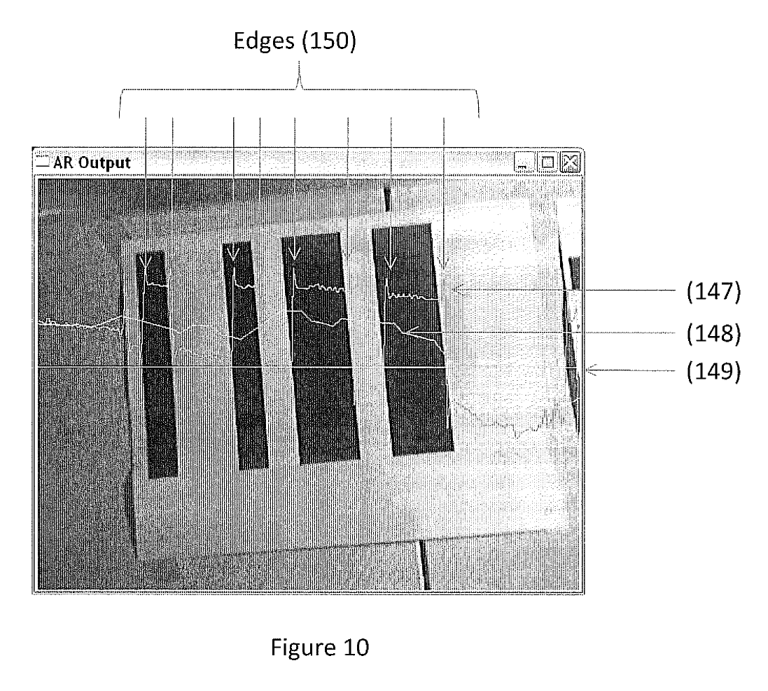

The algorithms for identifying these codes is relatively straightforward. The first step to barcode acquisition is to perform a high frequency horizontal line scan of the image at regular intervals along the width of the image (FIG. 10—image of code and (149) a single line scan). This line scan moves across the image horizontally and looks for high frequency changes in pixel values (e.g. black to white, white to black) and then records the location of the high frequency change (147). A second, lower frequency scan of the image is then performed along the line. This low frequency scan effectively runs an simple running average across the line and then repeats the original scan operation. This second scan helps to reduce noise from irregularly illuminated barcodes (148). The places where these two signals cross are where we find edges (150). The proportion of distances between subsequent edges is then used to find the barcode. This process is able find the barcodes at different distances and angles to the barcode, because the proportionality of the bars is largely preserved when the camera moves with respect to the barcode.

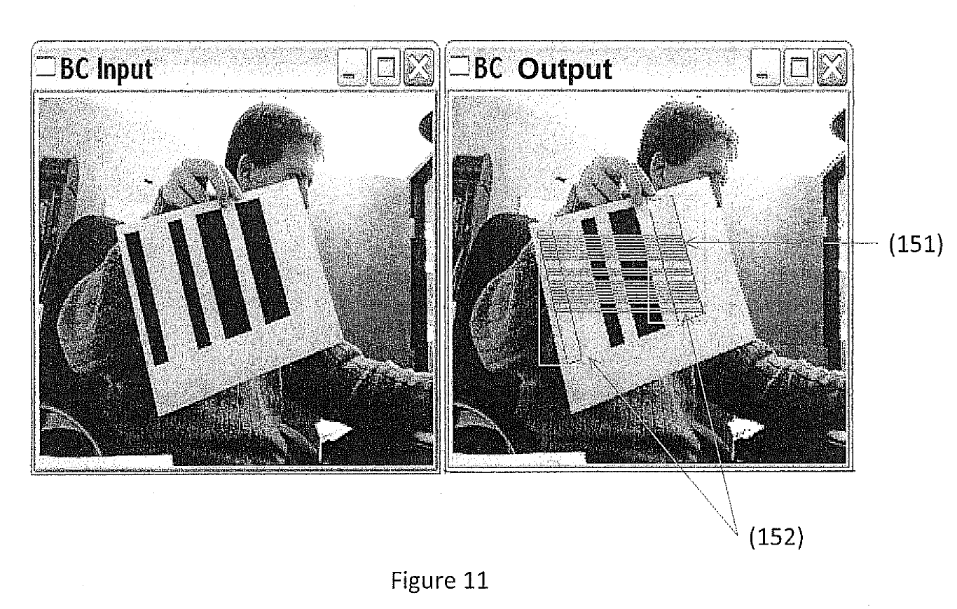

Once the barcode is detected and verified to occur within some number of consecutive lines (FIG. 11 (151)), the system performs a contour detection on the leading and trailing bars (152). This contour detection is performed by walking the edges of the barcode to and selecting the then moving along the barcode's edge until a corner, (143)-(146), is detected. The positions of these corners can then be further refined by sub pixel localization. From these 4 corners, and the known geometry of the barcode (i.e. its length and width) an extrinsic calibration determines the position and orientation of the barcode with respect to the camera. Since the barcode pose is defined with respect to the environment model, the camera's pose can be calculated by inverting the transformation.

Determining the camera's pose with respect to the synthetic barcode fiducial is a specialized case of the general markerless natural feature tracking approach using the four corner points, (143)-(146) as features. The general problem is determining the set of rotations and translations required to move the corners of the barcode image from its nominal position in space to the camera origin. The problem is estimating the projective matrix (homography) between the known positions of the barcode corners to the pixel space coordinates of the same corners in image space. This is accomplished using a direct linear transformation (DLT) algorithm. For barcodes this algorithm requires at minimum four correspondences that relate pixel space coordinates to the actual locations of the barcode in world space. The 3D real world space coordinates of the barcode are represented as the 2D barcode configuration plus two vectors representing the world space location and orientation of the barcode with respect to the global 3D world reference frame. The image pixel space locations of the barcode are represented as a 3 dimensional homogenous vector xᵢ while the values acquired from the four corners (143)-(146) as seen through the camera are represented as x′ᵢ. These points must be normalized prior to the application of the DLT algorithm. The steps of this normalization are as follows:

For each image independently (note that is the barcode is acquired from more than image the problem can be solved through least squares minimization). The coordinates are translated such that the centroid of all the points is at the origin of the image. Then the coordinates of each point are then scaled such that the average distance of all the points to the origin is the square root of two. The scaling and shifting factors used in the normalization are then saved for later use and factored out of the homography matrix. The problem then becomes determining H such that:

Hxᵢ=x′ᵢ

It is worth noting that if we denote the rows of H as h₁, h₂, h₃ and rearrange the equation we are left with

$$\begin{matrix}{x}_{i}^{′} \times {Hx}_{i} = [ \begin{matrix}{y}_{i}^{′} {h}^{3 T} {x}_{i} - {w}_{i}^{′} {h}^{2 T} {x}_{i} \\ {w}_{i}^{′} {h}^{1 T} {x}_{i} - {x}_{i}^{′} {h}^{3 T} {x}_{i} \\ {x}_{i}^{′} {h}^{2 T} {x}_{i} - {y}_{i}^{′} {h}^{1 T} {x}_{i}\end{matrix} ] \\ = 0\end{matrix}$$

Given that

h^{jT}xᵢ=xᵢ^{T}h^{j}

We can re-arrange the matrix above to the form

$$[ \begin{matrix}{0}^{T} & - {w}_{i}^{′} {x}_{i}^{T} & {y}_{i}^{′} {x}_{i}^{T} \\ {w}_{i}^{′} {x}_{i}^{T} & {0}^{T} & - {x}_{i}^{′} {x}_{i}^{T} \\ - {y}_{i}^{′} {x}_{i}^{T} & {x}_{i}^{′} {x}_{i}^{T} & {0}^{T}\end{matrix} ] ( \begin{matrix}{h}^{1} \\ {h}^{2} \\ {h}^{3}\end{matrix} ) = 0$$

This gives us the form Aᵢh=0, where Aᵢ is a 3×9 matrix. By using each of the n or more correspondences (where n>=4) we can then construct the 3n×9 matrix A by calculating Aᵢ for each of the n correspondences and concatenating the results. This matrix can then be used by singular value decomposition (SVD) algorithm to determine the homography matrix H. The output from the SVD algorithm is a set of matrices such that A=UDV^{T} and the matrix h from which we can derive H, is the last column of the matrix V.

The final homography matrix can then be un-normalized and the offset translation and rotations of the selected fiducials can be included in the homography matrix to give a global estimate of pose.

### Markerless or Natural Fiducial Pose System

The markerless pose detection system uses information about the prior pose and motion of the camera, as well as vision feature data to generate a pose estimate. The markerless system takes as its inputs an initial pose estimate from Position Fusion (108) subsystem that tracks the camera's position and orientation. This pose estimate is then used as the initial condition for a two-step pose determination processes.

Both processes determine pose by first extracting markerless features visible in camera imagery captured from that pose. These markerless features are be extracted using one or more of several feature detection algorithms [Lowe 2004] including Difference of Gaussians (DoG) [Lindenberg 1994], FAST-10 [Rosten, et al. 2003], SUSAN [Smith, et al. 1997], Harris Corner Detector [Harris, et al. 1988], Shi-Tomasi-Kanade detector [Shi, et al. 1994], or equivalent.

We call the first markerless pose determination process Delta Tracking, and the other we call the Known Point Tracker. These two processes (methods) work hand in hand to deliver the robust pose estimate. The delta tracker estimates pose change between frames while maintaining a local track of each feature. The known point tracker localizes the camera pose based on matching collections (or four or more features) to those pre-stored in keyframe associated with known camera poses (build or pre-mapped using methods already described).

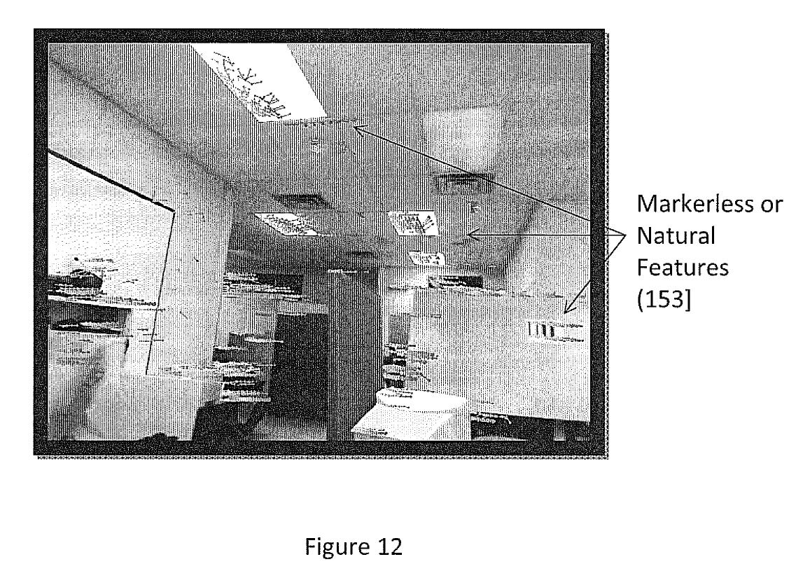

The first step in both algorithms is to find points of interest. This proceeds by applying the feature detection algorithm ([Lowe 2004] including Difference of Gaussians (DoG) [Lindenberg 1994], FAST-10 [Rosten, et al. 2003], SUSAN [Smith, et al. 1997], Harris Corner Detector [Harris, et al. 1988], Shi-Tomasi-Kanade detector [Shi, et al. 1994], or equivalent) producing features like those shown as highlights in FIG. 12 (153). Each feature detected and localized is store along with its location into a data structure. In the preferred implementation we use a version of FAST10 for computational efficiency but other methods are also possible (DoG being generally considered the best approach is computational time is not at a premium).

Delta Tracker—Fast Pose from the Last Known Pose

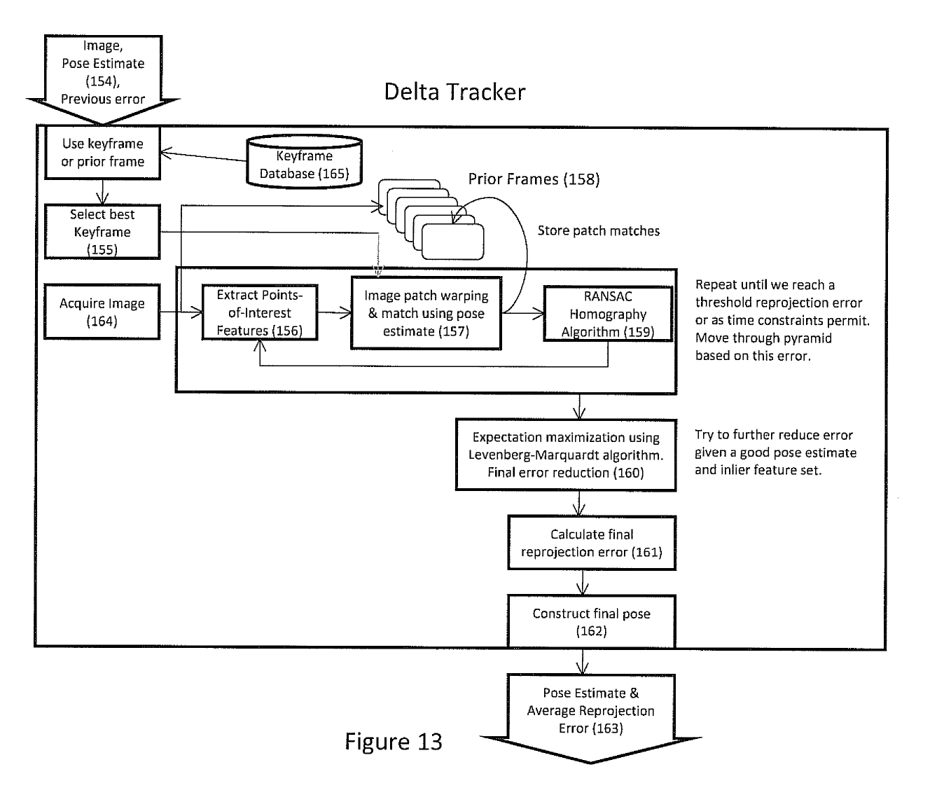

The Delta Tracker (FIG. 12) assumes that a reasonable pose estimate (from the last interation or from either the Known Point Tracker or the DMLO sensor) is available (154)(FIG. 13). We then proceed to match the current frame key point-of-interest (156) extracted from the acquire image (164) to the previous input image (158), otherwise we match to a keyframe image (155) that is located near to our estimated pose (154). If no keyframe or prior frame is visible we simply record the information and return an empty pose estimate.

If there is a prior frame we attempt to match features in the current frame (156) with features in the prior frame (158). To do this we use the difference between the previous pose estimate and the current pose estimate (from the Pose Fusion (108) Estimator) to generate a pose change estimate, effectively H inverse. This pose change estimate is used as an initial starting point for determining the pose of the overall scene, as we use the matrix to warp 9×9 pixel patches around each feature into the prior image, and then perform a convolution operation. If the convolution value falls below a particular threshold we consider the patches matched. If the number of matches is significantly less than the number of features in either image we perform a neighborhood search around each current patch and attempt to match a patch in the prior. This initial handful of matches is used to determine an initial pose change estimate using the RANSAC Homography Algorithm (159) described following:

RANSAC Homography Algorithm

Input: Corresponding point pairs

Output: Homography Matrix H, and an inlier set of pairs.

For N samples of the M input pairs

For N Times
Select 5 points at random from M
Make sure that the points are non collinear and not tightly clustered
Calculate a homography matrix H using 4D DLT.
Calculate the reprojection transfer error (e) of H over all points in M
Estimate number inliers by counting the number of error estimates below a preset threshold

Select H with the highest number of inliers and return this value

After applying this initial estimate of H, we refine our estimate by applying a similar procedure on a higher resolution image on the image pyramid. However this time we use a Maximum Likelihood (ML) Estimation approach versus the random sample consensus approach mentioned above. Essentially the RANSAC Homography approach gives us a good set of initial conditions for ML estimation. For the higher resolution image the feature correspondences are determined by applying the homography found previously and applying it to the current image, convolving image patches, and removing matches below a certain threshold. The RANSAC Homography algorithm is again applied to determine the set of inliers and outliers. We then use the Levenberg-Marquardt algorithm (160) [Levenverg 1944] [Marquardt 1963] to re-estimate H using the re-projection error of between the set of correspondences (161). The value of the re-projection error gives us a metric for the tracking quality of H. H can then be used as an estimate of the camera's change in pose (162) between the successive frames. When Keyframes are used the method is the same however there is a chance of the initial keyframe estimate being incorrect. If the initial low resolution RANSAC algorithm yields unsatisfactory results we use the pose from the estimate H to select a new keyframe from the set of keyframes. This process can be repeated with numerous keyframes and then selecting the one with the minimal low resolution re-projection error.

### Known Point Tracker

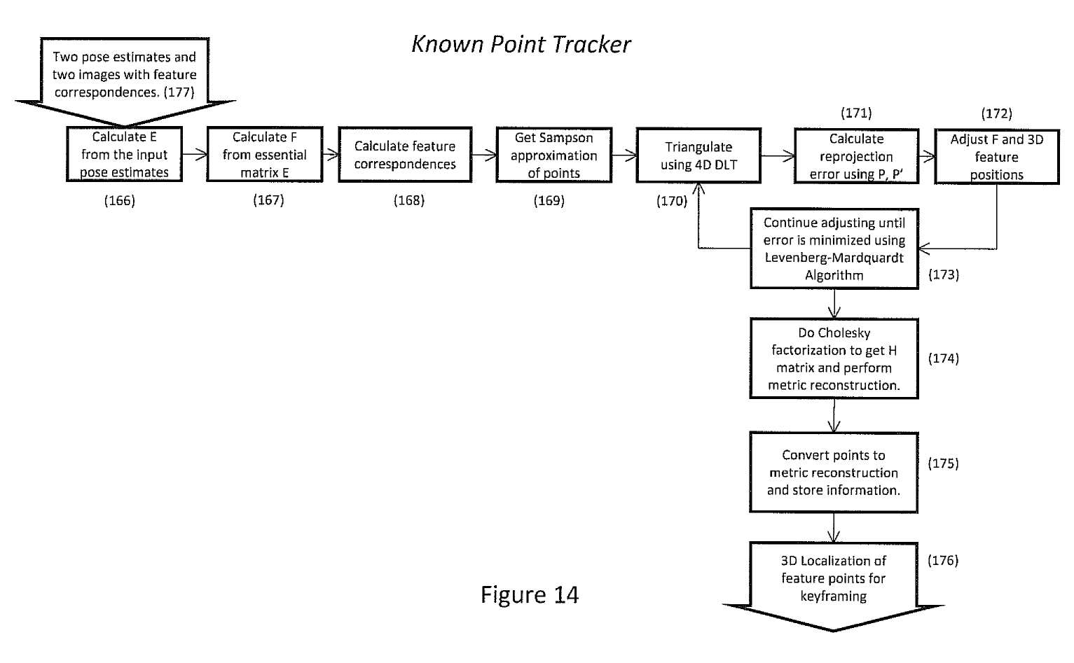

The Known Point Tracker (KPT), shown in FIG. 14, is an extension of the delta tracker, and is also be initialized using synthetic barcode fiducials. The KPT performs three major tasks: keyframing, position estimation, and position recovery. Keyframing and position estimation are by-products of robust pose determination. The delta tracker maintains a list of point correspondences between frames (177) as well as the estimated pose at each frame. These lists of correspondences are used in KPT to perform to estimate the position of each feature.

KPT is used to determining pose when a keyframe pose is sufficiently similar to the current pose estimate. This approach determines the change in pose between the known keyframe pose and the current camera pose. The camera's absolute position or homography is determined between the camera and keyframe. Keyframes are recalled based on the pose estimate provided by the Pose Fusion (108) process. Keyframes are stored in a key frame database (165), which is searched first on distance between the keyframe and estimated positions, and then by an examination of the overlap of the view frustum of the camera's orientation clamped to the environment map of augmentation area. To expedite this search keyframes are segmented in the database using logical partitions of the environment map. These partitions divide the keyframe search set based on rooms or other physical or artificial descriptions of the environment. This keeps the search space small and reduces search time as different datasets are loaded into memory based metrics such as possible travel paths through the space. It is often the case that multiple keyframes will map to the same camera pose estimate. In this case we extract an initial homography from each keyframe and then select the keyframe with the highest number inlier correspondences from the RANSAC Homography algorithm. The general algorithm to the KPT pose estimator is as follows:
KPT Pose Estimator
Input: Image, Pose Estimate, Keyframe Map,
Output: New Pose Estimate, Reprojection Error Average
Locate the N best keyframe matches to the pose estimate.
For each of the N keyframes:

Using the lowest pyramid level with features calculate the correspondences between the keyframe and the input image using the rotation between the estimated pose and the keyframe pose. If the correspondence quality is below a threshold reject the keyframe.

Apply and record the RANSAC Homography Algorithm, and select the keyframe with the smallest reprojection error.

Proceed as in the delta tracker and apply the calculated homography to the keyframe pose to estimate the current pose.

### KPT Point Localization

The KPT algorithm uses localized markerless features that have been tracked across multiple frames, each with a robust pose estimate. These pose estimates can be improved significantly by using synthetic barcode fiducials to determine intermediate camera's poses and high confidence DMLOs poses as a high accuracy ground-truth estimates.

KPT point localization can take place either as part of the real-time AR tracking system or during the initial setup and pre-mapping of the training environment. The minimum requirement is that we have tracks of a number of fiducials across at least two camera frames. Stereopsis is used to estimate the pose estimate of the camera at each frame. We calculate the fundamental matrix by using the camera calibration matrix and the essential matrix from these feature correspondences.

The essential matrix, E, has five degrees of freedom:
three degrees of freedom for rotation,
three degrees of freedom for translation, but
scale ambiguity leading to reduction to five degrees of freedom.

The essential matrix (166) is related to the fundamental matrix by the equation E=K^{T}FK where K is the camera calibration matrix. The essential matrix acts just like the fundamental matrix in that x′^{T}Ex=0. E can be composed by using the camera's normalized rotation matrix R and translation t:

E=[t]ₓR=R[R^{T}t]ₓ

Both R and t can be extracted from the two cameras pose values and are the difference in translation/rotation between the two poses. Using this data we extract an approximation of the fundamental matrix, F (167), between the two cameras. From this fundamental matrix we can use triangulation to calculate the distance to the features (using the (169) Sampson approximation). Using the camera calibration matrix we can change the projective reconstruction to a metric reconstruction (174).

There are a few degenerate cases where it is not possible to localize sets of features, the most important of these cases being when the features are co-planar (or near coplanar). Then the camera's change in pose is only from changes in orientations. This case can easily be accommodated by using DLMO data.

To localize feature online we first reconstruct the fundamental matrix, F (167), between the two camera views. The fundamental matrix is first generated using the pose estimates. We then select a subset of the visible point correspondences (168) to construct a more robust estimate of the fundamental matrix. To do this we first use stereopsis to determine the 3D position of the features using the Sampson approximation (169) and triangulation using a variant of the DLT (170) using a homogenous four dimensional vector (homogenous 3D coordinates). We then calculate the reprojection error of these 3D points (171) and use the Levenberg-Marquardt algorithm (173) to adjust the positions of the features and the camera parameters (172) to reduce this reprojection error. Given a good estimate of the fundamental matrix of the camera we then calculate the 3D position of the other features (175), and calculate a matrix that translates the features into a metric reconstruction using the calibration matrix (174).

### Point Localization Algorithm

Input: Two camera poses, a calibration matrix K, and a set of point correspondences xᵢ and x′ᵢ

Output: A set of metric 3D points corresponding to the features x, and x′ as well as robust estimate of the camera calibration matrix F.

Compute F using the essential matrix E derived from the pose change of the two cameras (167). Calculate the rotation matrix R and the translation t between the two cameras.

E=[t]ₓR=R[R^{T}t]ₓ

An initial estimate of F is determined as F=KEK^{T}=K^{-T}RK^{T}[KR^{T}t]ₓ We then refine F by using a maximum likelihood estimate of F using eight or more feature correspondences (168). We minimize a new set of point correspondences (denoted with a hat below) based on the reprojection error (171) between the two feature vectors. In this case d is the geometric distance between the reprojected features.

Σᵢd(xᵢ, x̅ᵢ)²+d(x′ᵢ, x̅′̅ᵢ)²

To perform the minimization we use our estimated fundamental matrix F′ to compute

P=[I|0]

and

P′=[[e′]ₓF′|e′]

where e′ is an epipole calculated from F′ by the relation F^{T}e′=0 To get the new estimate we then calculate the position of each feature in non-metirc three space where bold capital x (X) is point in three dimensions

x̅ᵢ̅=P X̅ᵢ

and

x̅′̅ᵢ̅=P X̅′̅ᵢ̅

To do this we use the Samspson approximation (169), or the first order correction to the position of the feature positions in normalized image space such that a ray from each of the stereo pair images will intersect at a real point in three space. Note that the value X and the hat modifiers do not mean three space coordinates. The Sampson approximation is given by

$$\begin{matrix}X = ( \begin{matrix}\hat{x} \\ \hat{y} \\ \hat{{x}^{′}} \\ \hat{{y}^{′}}\end{matrix} ) \\ = ( \begin{matrix}x \\ y \\ {x}^{′} \\ {y}^{′}\end{matrix} ) - \frac{{x}^{′ T} Fx}{{( Fx )}_{1}^{2} + {( Fx )}_{2}^{2} + {( {F}^{T} {x}^{′} )}_{1}^{2} + {( {F}^{T} {x}^{′} )}_{2}^{2}} ( \begin{matrix}{( {F}^{T} {x}^{′} )}_{1} \\ {( {F}^{T} {x}^{′} )}_{2} \\ {( Fx )}_{1} \\ {( Fx )}_{2}\end{matrix} )\end{matrix}$$

$${where \\ ( {F}^{T} {x}^{′} )}_{1} = {f}_{11} {x}^{′} + {f}_{22} {y}^{′} + {f}_{31}$$

While the Sampson correction will help us localize the features in three space, it will not satisfy the relationship x′Fx=0. The feature data, after applying the Sampson approximation is used to calculate the world position of the features X This is done using a direct analog of the DLT in three dimensional space. In this case we rearrange the equation

x×(PX)=AX=0

If we write the ith row of P as p^{iT} A can be defined as

$$A = [ \begin{matrix}{xp}^{3 T} - {p}^{1} T \\ {yp}^{3 T} - {p}^{2} T \\ {x}^{′} {p}^{′3 T} - {p}^{′ 1 T} \\ {y}^{′} {p}^{′ 3 T} - {p}^{′ 2} T\end{matrix} ]$$

We can then apply the DLT algorithm (170) as before to determine X. The solution X from the DLT is thus our point in three dimensional space. Using the We then use the Levenberg-Marquardt algorithm (173) to optimize x̅ᵢ=P X̅ᵢ̅, over the 3n+12 points in the equation where 3n is the number of features reconstructed, and 12 for the camera parameters. To translate the features into three dimensional space with world positions we must do the metric reconstruction (174) of the scene using the camera calibration matrix K.

What we want to find is 3D points in world space X_{Ei}. We need to find given

X_{Ei}=HXᵢ

and

H=A⁻¹0 0 1

given

P=[M|m]

We can find H using Cholesky factorization (174) to find H using the camera calibration matrix and the fundamental matrix.

AA^{T}=(M^{T}ωM)⁻¹=(M^{T}K^{-T}K⁻¹M)⁻¹

### Keyframing

The keyframing algorithm is a means of cataloging markerless natural features in a meaningful way so that they can be used for pose estimation. The keyframing procedure is performed periodically based on the length of the path traversed since the last keyframe was created, or the path length since a keyframe was recovered. The next metric used for keyframe selection is the quality of features in the frame. We determine feature quality by examining the number of frames over which the feature is tracked and how long a path over which the feature is visible. This calculation is completed by looking at the aggregate of features in any given frame, and it is assumed that features with an adequate path length already have a three dimensional localization.

The keyframing algorithm finds a single frame, out of a series of frames, which contains the highest number of features that exhibit good tracking properties. A good feature is visible over a large change in camera position and orientation and is consistently visible between frames. This information is determined from the track of the feature over time, and is then evaluates all of the features of the frame in aggregate. To find this frame we keep a running list of frames as well as features and their tracks. The first step of keyframing to iterate through the lists of feature tracks and remove all features where the track length is short (e.g. less than five frames) or the track is from a series of near stationary poses.

After this initial filtering we evaluate the tracks by determining the range of positions and orientation over which the pose is visible. This is accomplished by finding the minimum and maximum value for each pose value (x,y,z, pitch yaw roll) and subtracting the minimum from the maximum to get an extent vector. The extent vector is then normalized to maximum value that can be achieved in the set of frames evaluated. For each frame we then sum the extent vectors of each feature visible in a frame and select the frame with the largest extent vector. The image of this frame, along with its features and pose are stored as the keyframe.

### Pose Estimate Fusion (108)

After the execution of the three main pose determination strategies the results are then fused into a single pose estimate that is then used for final rendering. This fusion algorithm is similar to the pose fusion done internally to a DMLO device to fuse multiple direct measurement sensor outputs. As indicated in that discussion there are several possible fusion approaches. They include Kalman Filtering, Extended Kalman Filtering, and use of fuzzy logic or expert systems fusion algorithms.

The table below summarizes the inputs and outputs to each pose determination system as well as failure modes, update rates, and the basis for determining the estimate quality of each modality.

| | | | | | Quality |
|---|---|---|---|---|---|
| Method | Input | Output | Failure Mode | Rate | Analysis |
| DMLOs | None | Full or partial | Accuracy (CEP) | 100 Hz | Run Length & |
| | | orientation and | limitation | | quality of |
| | | location | Drift or | | absolute sensors |
| | | | disconnection | | if included (GPS, |
| | | | when not able to | | Tilt, |
| | | | locate an active | | Magnetometer) |
| | | | beacon or satellite | | |
| Synthetic | Camera | Full Position and | No fiducial or | 60 Hz | Barcode size and |
| Barcode | Image | Orientation | rapid camera | | orientation. |
| Fiducials | | | motion | | |
| Natural | Pose | Position and | Rapid motion | 60 Hz | Reprojection |
| Fiducials | Estimate | Orientation | No prior track | | Error |
| | Camera | | No keyframes (i.e. | | |
| | Image | | no natural fiducial) | | |
| GPS | None | Position and | Indoors - no line | 10 Hz | GPS Signal |
| | | heading if | of sight to | | quality |
| | | moving | satellites | | Number of |
| | | | | | Satellites in sight |

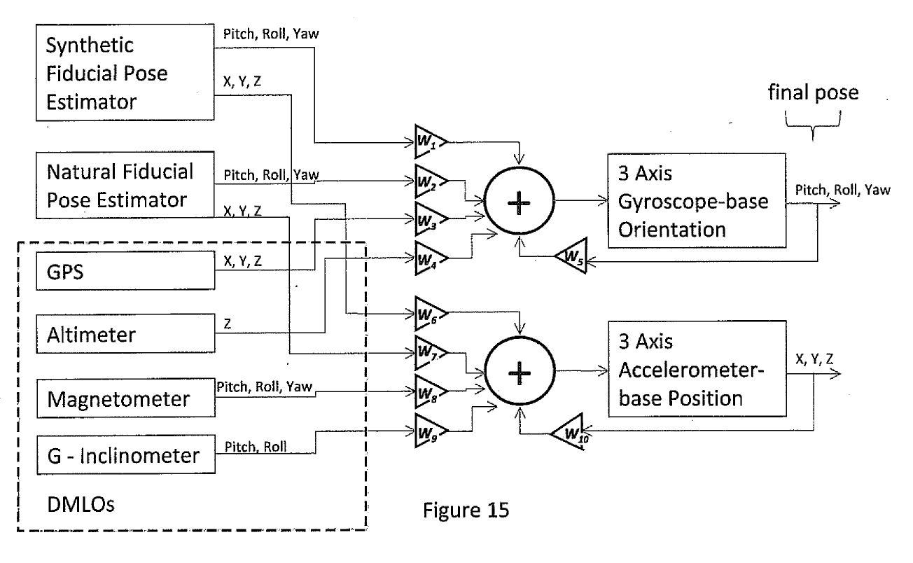

The general approach to fusing these values is to use the fastest updating sensors with the lowest noise as core and then use the most absolute sensors to correct for drift. FIG. 15 shows this conceptual approach.

### Pose Fusion Algorithm

Run Pose estimators and get results with error estimates.

If the camera based methods return pose, use the returned pose of the method with the least error.

If these two systems fail, get a position estimate from the pose fusion estimator, and merge it with the prior frame's orientation plus the DLMO deltas. If we have a new high confidence GPS position estimate use that as the pose position.

Feed the current pose estimate into the pose fusion estimator with error bounds based on the pose source.

After the final pose is calculated it is ready to be used by the final rendering system.

### Final Rendering

To render augmented reality information onto the scene we need the input video stream, the current camera pose, the cameras intrinsic parameters, and the environment augmenting model. To render the augmented reality content the virtual camera within the rendering environment is adjusted to match the real camera pose. The virtual camera is set to have the same width, height, focal length, and field of view of the real camera. The imagery is then undistorted using the intrinsic calibration matrix of the camera, and clamped to the output viewport. The virtual camera's pose is then set to the estimated pose. Synthetic imagery can then be added to the system using the environment augmenting model to constrain whether synthetic imagery is visible or not. The environment augmenting model can also be used for path planning of moving synthetic objects. Markerless natural features with known positions can also be used to add to the environment map in real time and used for further occlusion handling. This occlusion handling is accomplished by locating relatively co-planar clusters of features and using their convex hull to define a mask located at a certain position, depth and orientation.

We claim:

1. A method of pose determination in an augmented reality system, comprising the steps of:
placing at least one synthetic fiducial in a real environment to be augmented;
providing a camera including apparatus for obtaining directly measured camera location and orientation (DLMO) information;
acquiring an image of the environment with the camera;
detecting the natural and synthetic fiducials;
estimating the pose of the camera using a combination of the natural fiducials, the synthetic fiducial if visible in the image, and the DLMO information if determined to be reliable or necessary.

2. The method of claim 1, wherein the synthetic fiducial is in the form of a bar code.

3. The method of claim 1, wherein the DLMO information is derived through inertial measurement.

4. The method of claim 1, wherein the DLMO information is derived through GPS or RF location measurement.

5. The method of claim 1, wherein the DLMO information is derived through sensor data.

6. The method of claim 1, wherein the DLMO information is obtained from an altimeter, accelerometer, gyroscope or magnetometer.

7. The method of claim 1, including the step of determining and recording the position of natural fiducials in the form of keyframes.

8. The method of claim 1, including the steps of:
determining the pose of a first fiducial A;
imaging the environment with a field of view including A and another fiducial, B; and
determining the pose of B using the pose of A and the offset between A and B.

9. The method of claim 8, including the steps of
imaging the environment with a field of view including B and another fiducial, C;
determining the pose of C using the pose of B and the offset between B and C; and
wherein the rotation and translation between A, B and C, if any, is represented by a quaternion.

10. A method of determining the pose (position and orientation) of a plurality of fiducials in an environment, comprising the steps of:
determining the pose of a first fiducial, A;
imaging the environment with a field of view including A and a plurality of other fiducials; and
determining the pose of the other fiducials by batch optimizing the translation between some or all of the fiducials within the field of view, thereby eliminating the need for the DLMO information.

11. The method of claim 1, including the steps of:
merging augmentations with the image of the real environment; and
presenting the augmented image to a viewer.

12. The method of claim 1, including the steps of:
generating augmentations in the form of synthetic 3D or 2D graphics, icons, or text;
merging augmentations with the image of the real environment; and
presenting the augmented image to a viewer.

13. The method of claim 1, including the steps of:
merging augmentations with the image of the real environment; and
presenting the augmented image to a viewer through a head-mounted display, touch screen display or portable computing or telecommunications device.

14. An augmented reality system, comprising:
a camera for imaging a real environment to be augmented, the camera including apparatus for obtaining directly measured camera location and orientation (DLMO) information;
at least one synthetic fiducial positioned in the environment; and
a processor operative to detect the natural and synthetic fiducials in the image acquired by the camera and estimate the pose of the camera using a combination of the natural fiducials, the synthetic fiducials if visible in the image, and the DLMO information if determined to be reliable or necessary.

15. The system of claim 14, wherein the synthetic fiducial is a bar code.

16. The system of claim 14, wherein the apparatus for obtaining the DLMO information is an inertial measurement system.

17. The system of claim 14, wherein the apparatus for obtaining the DLMO information is a GPS or RF location measurement system.

18. The system of claim 14, wherein the apparatus for obtaining the DLMO information is an altimeter, accelerometer, gyroscope or magnetometer or other sensor.

19. The system of claim 14, further including:
the same or a different processor for generating augmentations in the form of synthetic 3D or 2D graphics, icons, or text and merging the augmentations with the image of the real environment; and
a display for presenting the augmented image to a viewer.

20. The system of claim 19, wherein the display forms part of a head-mounted display, touch screen display or portable computing or telecommunications device.
